(19) United States
(12) Patent Application Publication
(10) Pub. No.: US 2008/0116031 A1
(43) Pub. Date: May 22, 2008

(54) Slave Cylinder

(75) Inventor: Thomas Rammhofer, Sasbach (DE)

Correspondence Address: Davidson, Davidson & Kappel, LLC, 485 7th Avenue, 14th Floor, New York, NY, 10018, US

(73) Assignee: LuK Lamellen und Kupplungsbau Beteiligungs KG, Buehl (DE)

(21) Appl. No.: 11/666,777

(22) PCT Filed: Oct. 15, 2005
(86) PCT No.: PCT/DE05/01843

§ 371 Date: May 1, 2007

(30) Foreign Application Priority Data
Nov. 5, 2004 (DE) 10 2005 053 484.5

(51) Int. Cl. F16D 25/08

(52) U.S. Cl. 192/85 C

(57) ABSTRACT

A slave cylinder, especially for a hydraulic system of a motor vehicle, the slave cylinder including a housing with an outer tube and a fixing ring, and a guiding sleeve including an inner tube. The outer tube and the inner tube define a pressure chamber wherein a ring piston can be arranged in an axially displaceable manner, and the guiding sleeve includes a fixing plate which is pressed against the fixing ring. A seal is arranged in a sealing groove between the inner region and the fixing plate, and a device for exerting an axial force of the fixing ring on the fixing plate is arranged in the outer region of the fixing ring. An object of the invention is to prevent the seal between the housing and the inner tube from failing, or at least to reduce the probability thereof under high internal pressures. To this end, the surface pressure generated between the inner region and the fixing plate by the device exerting an axial force is higher than an expansion tension exerted thereon during operation by pressure from the pressure chamber.

### BACKGROUND INFORMATION

The present invention relates to a slave cylinder, in particular for a hydraulic system of a motor vehicle, including a housing having an outer tube and a fixing ring, and a guiding sleeve provided with an inner tube, outer tube and inner tube delimiting a pressure chamber in which a ring piston may be axially displaceably situated, and the guiding sleeve including a fixing plate which is pressed against the fixing ring, a seal being situated between the internal area and the fixing plate in a seal groove, and means for exerting an axial force of the fixing ring on the fixing plate being situated in an external area of the fixing ring.

A slave cylinder according to the species is known from DE 102 22 730, in which the pressure chamber is delimited by an internal metallic cylinder and an external plastic housing. The two components are connected by being screwed onto the transmission housing, a seal for sealing the pressure chamber to the outside being situated between the two components.

A further slave cylinder is known from DE 43 13 346, for example. The pressure chamber is formed here by two metal tubes situated concentrically to one another, which are welded to one another on the side facing the transmission housing.

The pressure which exists in the pressure chamber during operation exerts a so-called expansion force on the pressure-chamber-side connection point of the two components, i.e., between the guiding sleeve and the plastic housing, which attempts to push the two parts apart. The expansion force arises in that, due to the internal pressure and the pressure force thus acting perpendicularly to the surface, an (initially small) peripheral notch is pressed into the seat area between the two components, so that a surface is created which may be acted upon in the axial direction. The pressure force thus produces a peripheral notch which is wedge-shaped in section, which allows an axially acting expansion force. The larger this notch, the stronger the expansion force at the same pressure - because the effective area increases. The seal between the two components may thus be relieved of pressure axially so much that it no longer withstands the radially acting pressure and fails. If components are welded to one another, i.e., if the guiding sleeve and the housing are made of materials which are weldable to one another—usually metals—this problem is usually not too severe because of the connection, to which higher loads may be applied. However, if the components are not welded all around, but rather only in spots, the cited problem may also occur.

The object of the present invention is therefore to provide a slave cylinder, in which the seal between the housing and the inner tube does not fail or is at least less likely to fail under high internal pressures.

This object is achieved by a slave cylinder, in particular for a hydraulic system of a motor vehicle, including a housing having an outer tube and a fixing ring as well as a guiding sleeve having an inner tube, outer tube and inner tube delimiting a pressure chamber, in which a ring piston may be axially displaceably situated, and the guiding sleeve including a fixing plate, which is pressed against the fixing ring, a seal being situated between the internal area and the fixing plate in a seal groove and means for exerting an axial force of the fixing ring on the fixing plate being situated in an external area of the fixing ring, characterized in that the surface pressure between the internal area and the fixing plate, which is caused by the means for exerting an axial force, is greater than an expansion stress exerted thereon by pressure exerted on the pressure chamber during operation. Expansion stress is to be understood here as the expansion force opposing the surface pressure locally in relation to a unit area. The inner tube is preferably manufactured from metal and the housing is preferably manufactured from plastic. The surfaces facing one another (on which the ring piston thus slides) are preferably approximately cylindrical.

The means for exerting an axial force of the fixing ring on the fixing plate may be a flange of the fixing plate around the fixing ring, but may alternatively or additionally also be (multiple) screws for fixing the slave cylinder to a transmission housing. The screws preferably project through screw eyes of the external area of the fixing ring into threaded holes of the transmission housing.

The external area preferably has a distance from the transmission housing, so that the contact pressure of the screws is essentially only introduced into the transmission housing via the internal area of the fixing ring. The external area thus does not press against the slave cylinder when it is mounted on the transmission housing, so that the slave cylinder is only supported on the transmission housing in the internal area. Thus, with the same contact pressure as with contact over the entire area, the surface pressure of the contacting surface is increased; in addition, this pressure is exerted in the critical area directly around the pressure chamber.

In a refinement, it is provided that a rear surface of the housing facing toward the fixing plate is implemented as peripherally wavy in the non-deformed, unmounted state. The rear surface of the housing is the contact surface running essentially radially on the fixing plate. The surface shape may be planar viewed in the axial direction; an arbitrary radial section thus has an essentially linear surface, but may also have different axial heights in the radial direction. For example, the peripheral waves may additionally run diagonally in the radial direction or in a spiral or the like.

Preferably, it is provided that wave valleys lie in the area of the screw eyes and wave peaks lie in areas between the screw eyes. The surface pressure is thus distributed uniformly around the circumference in the screwed-on state.

The wavy implementation preferably approximately corresponds to a sinusoidal curve. This is to be understood to mean that a development at a constant radius approximately results in a sinusoidal curve. The sinusoidal curve preferably has an amplitude (measured as spacing of linear envelopes between wave peak and wave valley) of approximately 0.05 mm to 0.6 mm, preferably approximately 0.2 mm.

The object cited at the beginning is also achieved by a slave cylinder system, in particular for a hydraulic system of a motor vehicle, on a transmission housing, the slave cylinder including a housing having an outer tube and a fixing ring as well as a guiding sleeve having a cylindrical inner tube, and the outer tube and the cylindrical inner tube delimiting a pressure chamber, in which a ring piston may be axially displaceably situated, and the guiding sleeve including a fixing plate, which is situated in the installed position of the slave cylinder between an internal area of the fixing ring and a transmission housing, a seal being situated in a seal groove between the internal area and the fixing plate and screw eyes for receiving screws, using which the slave cylinder is fixed to the housing, being situated in an external area of the fixing ring, characterized in that the external area has a distance from the transmission housing, so that the contact pressure of the screws is introduced into the transmission housing essentially only via the internal area of the fixing ring.

In the following, an exemplary embodiment of the present invention is explained on the basis of the appended drawing.

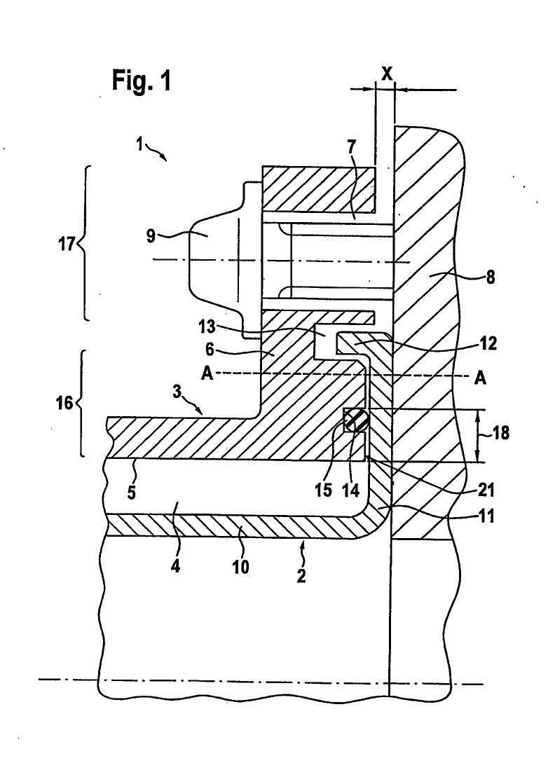

FIG. 1 shows a schematic cross section through a hydraulic slave cylinder;

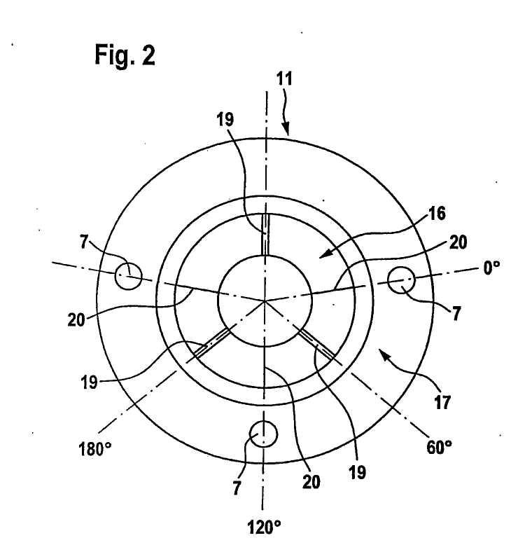

FIG. 2 shows an illustration of the mounting surface of the housing;

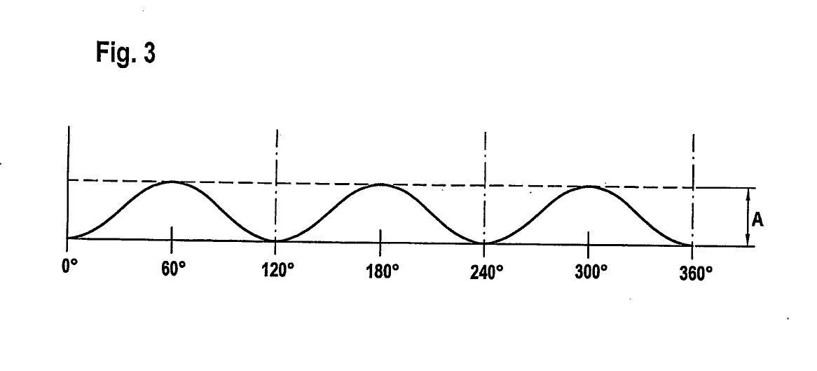

FIG. 3 shows a development of the housing along a peripheral section edge A-A in FIG. 1.

FIG. 1 shows a partial section through a slave cylinder 1 of a hydraulic system of a motor vehicle, a so-called centralized servo cylinder (abbreviation: CSC). This includes a guiding sleeve 2, which is situated essentially coaxially to a transmission input shaft (not shown here). Guiding sleeve 2 is connected to a housing 3, guiding sleeve 2 and housing 3 enclosing a pressure chamber 4, in which a ring piston (not shown here) is movably situated to operate a throwout bearing of a vehicle clutch, for example. Pressure chamber 4 is connected to a supply line (not shown here) of the hydraulic system, so that hydraulic pressure of a master cylinder, for example, may be applied to it.

Housing 3 essentially includes an outer tube 5, which delimits actual pressure chamber 4. Outer tube 5 passes into an essentially radially extending peripheral fixing ring 6, which includes screw eyes 7 for fixing slave cylinder 1 using screws 9 on a transmission housing 8 (schematically illustrated here). Typically, three screw eyes 7 are situated distributed around the circumference of housing 3, but two or four or more screw eyes 7 may also be provided here, however.

Guiding sleeve 2 includes a cylindrical inner tube 10, which passes into a peripheral fixing plate 11 extending essentially radially outward. This in turn passes radially outward into a groove ring 12, which engages a peripheral ring groove 13 of housing 3.

When the slave cylinder 1 is mounted and fixed on transmission housing 8, fixing plate 11 lies between transmission housing 8 and housing 3 of the CSC. A seal 15, for example, in the form of an 0-ring or a molded seal, is inserted into a peripheral sealing groove 14 for sealing.

Viewed in the radial direction, the face of housing 3 facing transmission housing 8 may be imagined to be divided into an internal area 16, which extends from pressure chamber 4 up to peripheral ring groove 13, and an external area 17, which extends further outward radially from the ring groove. Internal area 16 is used for sealing pressure chamber 4 to the outside; external area 17 is essentially only used for receiving screw eyes 7. External area 17 has a distance X from transmission housing 8 in the mounted state. This has the result that only a contact pressure is exerted essentially in internal area 16 in the direction of transmission housing 8 by tightening screws 9. External area 17 thus does not press against transmission housing 8 even after screws 9 are tightened. Internal area 16 may thus be pressed against fixing plate 11 and thus transmission housing 8 with a pre-tension which results in a locally high surface pressure.

A so-called expansion surface 18 lies between internal area 16 and fixing plate 11, which essentially arises because hydraulic liquid is pressed into the gap between housing 3 and fixing plate 11 and presses the two apart, so that a force acting in the axial direction against the contact pressure exerted using screws 9 acts in this area. If the force exerted on expansion surface 18 becomes greater than the contact pressure (i.e., the local expansion stress as expansion force per unit area is greater than the opposing surface pressure), the area of the transition face between housing 3 and fixing plate 11 facing toward pressure chamber 4 slowly detaches, so that the gap is further enlarged. If the gap becomes so large that the seal is only still clamped with a small axial force or no axial force, the seal fails and hydraulic liquid escapes. The expansion force is a function of effective expansion surface 18 and the pressure in pressure chamber 4.

Overshoot X allows screws 9 to be tightened in such a way that such a high surface pressure is to be caused in the axial direction on transmission housing 8 in the area of expansion surface 18 that this surface pressure is generally higher than the pressure force exerted by the pressure in pressure chamber 4 in this area. Therefore, no gap or only a small gap arises, so that expansion surface 18 at least does not reach seal 15.

Fixing plate 11 may be flanged around a housing 3 of the CSC in external area 17. The flanging may be performed in such a way that the contact pressure force between housing 3 and fixing plate 11 described above is solely produced thereby.

A particularly uniform distribution of the contact pressure around the circumference of housing 3 is achieved if rear face 21 of internal area 16, which faces stop plate 11 and presses against it in the installed position, is additionally wavy viewed in the circumferential direction in the uninstalled state. This is shown in a perspective illustration in FIG. 2. The waves do not extend in the radial direction, but rather in the circumferential direction. Wave peaks 19 are shown in FIG. 2 as double lines, wave valleys 20 as single lines. Wave peaks 19 and wave valleys 20 run essentially radially, which is indicated by dashed auxiliary lines in radial extension. For simpler illustration, FIG. 3 therefore shows a development along section A-A in FIG. 1, the section being performed in the circumferential direction of slave cylinder 1, which is rotationally symmetric per se; the peripheral angle is marked in each case on radial auxiliary lines through wave peaks 19 and wave valleys 20 and plotted over the abscissa in FIG. 3. In addition, screw eyes 7 are indicated as vertical dot-dash lines in FIG. 3. As is shown, this is an essentially sinusoidal surface having an amplitude A (measured between wave peak and wave valley), wave peaks 19 being situated between screw eyes 7 and wave valleys 20 being situated in the area of screw eyes 7. In this way, in spite of elastic deformation of housing 3 when screws 9 are tightened, a surface pressure distributed comparatively uniformly over the circumference results in the area of seal 15.

### List of Reference Numerals

1 slave cylinder
2 guiding sleeve
3 housing
4 pressure chamber
5 outer tube
6 fixing ring
7 screw eyes
8 transmission housing
9 screws
10 cylindrical inner tube
11 fixing plate
12 groove ring
13 peripheral ring groove
14 peripheral sealing groove
15 seal
16 internal area
17 external area
18 expansion surface
19 wave peaks
20 wave valleys
21 rear face

1-8. (canceled)

9. A slave cylinder comprising:
a housing including an outer tube and a fixing ring, the fixing ring having a radially internal area and a radially external area;
a guiding sleeve including an inner tube and a fixing plate, the outer tube and the inner tube defining a pressure chamber for receiving an axially-displaceable ring piston, the fixing plate contacting the fixing ring;
a seal between the internal area and the fixing plate in a sealing groove in at least one of the fixing plate and the fixing ring; and
a device in an external area of the fixing ring, the device exerting an axial force of the fixing ring on the fixing plate, a surface pressure between the internal area and the fixing plate caused by the device exerting the axial force being greater than an expansion stress exerted by pressure of the pressure chamber during operation.

10. The slave cylinder as recited in claim 9 wherein the slave cylinder is for a hydraulic system of a motor vehicle.

11. The slave cylinder as recited in claim 9 wherein the device exerting an axial force includes a flange connected to the fixing plate, the flange being located around the fixing ring.

12. The slave cylinder as recited in claim 9 wherein the device exerting an axial force includes screws for fixing the slave cylinder on a transmission housing.

13. The slave cylinder as recited in claim 12 wherein the screws project through screw eyes of the external area into threaded holes of the transmission housing.

14. The slave cylinder as recited in claim 13 wherein the external area has a distance from the transmission housing so that the screws cause a force to be exerted against the transmission housing solely via the internal area.

15. The slave cylinder as recited in claim 9 wherein a rear face of the housing facing the fixing plate has a peripherally wavy design in the non-deformed, unmounted state.

16. The slave cylinder as recited in claim 15 wherein the housing includes screw eyes and the wavy design of the rear face corresponds to a sinusoidal curve, wave valleys lying circumferentially in an area of the screw eyes and wave peaks lying circumferentially in areas between the screw eyes, the sinusoidal curve having an amplitude of approximately 0.05 mm to 0.6 mm.

17. A slave cylinder on a transmission housing, the slave cylinder comprising:
a housing including an outer tube and a fixing ring having a radially internal area and a radially external area;
a guiding sleeve including a fixing plate and a cylindrical inner tube, the outer tube and the cylindrical inner tube defining a pressure chamber for an axially-displaceable ring piston, the fixing plate situated in an installed position of the slave cylinder between the internal area of the fixing ring and a transmission housing, and
a seal between the internal area and the fixing plate in a sealing groove of at least one of the fixing plate and the fixing ring, and the external area having screw eyes for receiving screws for fixing the slave cylinder to the transmission housing, the external area having a distance from the transmission housing so that contact pressure of the screws causes a force to be exerted against the transmission housing solely via the internal area.

18. A slave cylinder comprising:
a housing including an outer tube and a fixing ring, the fixing ring having a radially internal area and a radially external area;
a guiding sleeve including an inner tube and a fixing plate, the outer tube and the inner tube defining a pressure chamber for receiving an axially-displaceable ring piston, the fixing plate contacting the fixing ring;
a seal between the internal area and the fixing plate in a sealing groove in at least one of the fixing plate and the fixing ring; and
means for exerting an axial force of the fixing ring on the fixing plate, the means being located in the external area, a surface pressure between the internal area and the fixing plate caused by the device exerting the axial force being greater than an expansion stress exerted by pressure of the pressure chamber during operation.
